(19) United States
(12) Patent Application Publication
(10) Pub. No.: US 2009/0141410 A1
(43) Pub. Date: Jun. 4, 2009

(54) CURRENT-PERPENDICULAR-TO-THE-PLANE STRUCTURE MAGNETORESISTIVE ELEMENT AND METHOD OF MAKING THE SAME AND STORAGE APPARATUS

(75) Inventors: Arata Jogo, Kawasaki (JP); Takahiro Ibusuki, Kawasaki (JP); Yutaka Shimizu, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/209,824

(22) Filed: Sep. 12, 2008

(30) Foreign Application Priority Data
Dec. 3, 2007 (JP) 2007-312423

(51) Int. Cl. G11B 5/33

(52) U.S. Cl. 360/324.2; G9B/5.104

(57) ABSTRACT

An electrically-conductive or insulating non-magnetic intermediate layer is inserted between a free magnetic layer and a pinned magnetic layer in a current-perpendicular-to-the-plane (CPP) structure magnetoresistive element. At least one of the free magnetic layer and the pinned magnetic layer is made of a nitrided magnetic metal alloy. This nitrided magnetic layers allows the CPP structure magnetoresistive element to enjoy an increased magnetoresistance change (ΔRA). In addition, the saturation magnetic flux density (Bs) decreases in a nitrided magnetic metal alloy. The inversion of magnetization is thus easily caused in the low Bs magnetic layer. The detection sensitivity of the CPP structure magnetoresistive element is improved. The CPP structure magnetoresistive element is thus allowed to detect magnetic bit data with higher accuracy.

### BACKGROUND OF THE INVENTION

1. Field of the Invention

The present invention relates to a magnetoresistive (MR) element utilizing a magnetoresistive (MR) film such as a spin valve film, a tunnel-junction film, and the like. In particular, the invention relates to a current-perpendicular-to-the-plane (CPP) structure magnetoresistive element in which a sensing current flows in the direction of lamination of a film stack constituting the magnetoresistive element.

2. Description of the Prior Art

A current-perpendicular-to-the-plane structure magnetoresistive element including a so-called spin-valve film is well known. The spin-valve film includes a free magnetic layer having electrical conductivity and a pinned magnetic layer having electrical conductivity. A non-magnetic layer is inserted between the free magnetic layer and the pinned magnetic layer. An antiferromagnetic layer fixes the magnetization in the pinned magnetic layer in a single direction. The direction of magnetization in the free magnetic layer rotates in response to a signal magnetic field applied from magnetization recorded on a magnetic recording disk. The rotation of magnetization in the free magnetic layer induces a significant change in the electric resistance of the spin-valve film. When a sensing current is supplied to the spin-valve film in the perpendicular direction normal to the spin-valve film, a change appears in the level of an electrical signal output from the spin-valve film in response to the change in the electric resistance. This change in the level is utilized to detect magnetic bit data recorded on the magnetic recording disk.

It is required to increase a change in the magnetoresistance per unit area of the free magnetic layer so as to improve detection sensitivity to magnetic bit data. So-called tBs (t=thickness of a magnetic layer, Bs=saturation magnetic flux density) is referred to as an index for the magnetoresistance per unit area. The smaller the tBs gets, the smaller the magnetic moment becomes. Accordingly, when the free magnetic layer is made of a magnetic material having a small value of tBs, for example, the direction of magnetization easily rotates in response to a signal magnetic field applied from a magnetic recording disk. This results in improvement of the detection sensitivity. In the case where the free magnetic layer and the pinned magnetic layer are made of a magnetic material such as CoFe, NiFe, or the like, as disclosed in Japanese Patent Application Publication No. 2002-92829, for example, it is usually required to increase the thickness of these layers so as to increase magnetoresistance. However, when the thickness is increased, the tBs is increased. Increase in the tBs leads to deterioration of the detection sensitivity.

### SUMMARY OF THE INVENTION

It is accordingly an object of the present invention to provide a current-perpendicular-to-the-plane structure magnetoresistive element enabling detection of magnetic bit data with higher accuracy. It is an object of the present invention to provide a method of making the same.

According to a first aspect of the present invention, there is provided a current-perpendicular-to-plane (CPP) structure magnetoresistive (MR) element comprising: a free magnetic layer having electrical conductivity; a pinned magnetic layer having electrical conductivity; and an electrically-conductive non-magnetic intermediate layer inserted between the free magnetic layer and the pinned magnetic layer, wherein at least one of the free magnetic layer and the pinned magnetic layer is made of a nitrided magnetic metal alloy.

The inventors have confirmed through observation the CPP structure MR element enjoying an increased magnetoresistance change (ΔRA) when at least one of the free magnetic layer and the pinned magnetic layer is made of a nitrided magnetic metal alloy. The CPP structure MR element is allowed to enjoy an enhanced output. In addition, the saturation magnetic flux density (Bs) decreases in a nitrided magnetic metal alloy. The reversion of magnetization is thus easily caused in the magnetic layer. The detection sensitivity of the CPP structure MR element is improved. The CPP structure MR element is thus allowed to detect magnetic bit data with higher accuracy.

In the CPP structure MR element, the aforementioned magnetic metal alloy may be made of at least one of NiFeN, CoFeN, CoFeNiN, CoFeAlN, CoFeGeN, CoFeSiN, and CoFeMgN. Such a CPP structure MR element can be incorporated in a storage apparatus, for example.

A specific method may be provided to make the aforementioned CPP structure MR element. The specific method may comprise forming a layered structure on the surface of a substratum, the layered structure including a free magnetic layer having electrical conductivity, a pinned magnetic layer having electrical conductivity, and an electrically-conductive non-magnetic intermediate layer inserted between the free magnetic layer and the pinned magnetic layer, where in a magnetic metal alloy is layered in an atmosphere containing at least an N₂ gas in a process of forming at least one of the free magnetic layer and the pinned magnetic layer. In the method, at least one of the free magnetic layer and the pinned magnetic layer is made of a nitrided magnetic metal alloy. The aforementioned CPP structure MR element is in this manner produced.

According to a second aspect of the present invention, there is provided a current-perpendicular-to-the-plane (CPP) structure magnetoresistive (MR) element comprising: a free magnetic layer having electrical conductivity; a pinned magnetic layer having electrical conductivity; and an insulating non-magnetic intermediate layer inserted between the free magnetic layer and the pinned magnetic layer, wherein at least one of the free magnetic layer and the pinned magnetic layer is made of a nitrided magnetic metal alloy.

The CPP structure MR element is allowed to enjoy an increased magnetoresistance change (ΔRA) when at least one of the free magnetic layer and the pinned magnetic layer is made of a nitrided magnetic metal alloy in the same manner as described above. The CPP structure MR element is allowed to enjoy an enhanced output. In addition, the saturation flux magnetic density (Bs) decreases in a nitrided magnetic metal alloy. The reversal of magnetization is thus easily caused in the magnetic layer. The detection sensitivity of the CPP structure MR element is improved. The CPP structure MR element is thus allowed to detect magnetic bit data with higher accuracy.

In the CPP structure MR element, the aforementioned magnetic metal alloy may be made of at least one of NiFeN, CoFeN, CoFeNiN, CoFeAlN, CoFeGeN, CoFeSiN, and CoFeMgN. Such a CPP structure MR element can be incorporated in a storage apparatus, for example.

A specific method may be provided to make the aforementioned CPP structure MR element. The specific method may comprise forming a layered structure on the surface of a substratum, the layered structure including a free magnetic layer having electrical conductivity, a pinned magnetic layer having electrical conductivity, and an insulating non-magnetic intermediate layer inserted between the free magnetic layer and the pinned magnetic layer, wherein a magnetic metal alloy is layered within a high vacuum atmosphere containing at least an N₂ gas in a process of forming at least one of the free magnetic layer and the pinned magnetic layer. In the method, at least one of the free magnetic layer and the pinned magnetic layer is made of a nitrided magnetic metal alloy. The aforementioned CPP structure MR element is in this manner produced.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the inner structure of a hard disk drive as a specific example of a storage apparatus according to a first embodiment of the present invention;

FIG. 2 is an enlarged perspective view schematically illustrating a flying head slider according to a specific example;

FIG. 3 is a front view schematically illustrating a read/write electromagnetic transducer observed at a bottom surface of the flying head slider;

FIG. 4 is an enlarged view schematically illustrating a spin-valve film according to a first specific example of the present invention;

FIG. 5 is a graph illustrating the relationship between the ratio of N₂ gas and the resistivity;

FIG. 6 is a graph illustrating the relationship between the ratio of N₂ gas and the saturation magnetic flux density;

FIG. 7 is a graph illustrating the relationship between the ratio of N₂ gas and the magnetoresistance change ARA;

FIG. 8 is a graph illustrating the relationship between the total thickness of a free magnetic layer and a pinned magnetic layer and the magnetoresistance change ΔRA in a conventional spin-valve film;

FIG. 9 is a graph illustrating the relationship between tBs and the magnetoresistance change ΔRA in a conventional spin-valve film;

FIG. 10 is an enlarged view schematically illustrating a spin-valve film according to a second specific example of the present invention;

FIG. 11 is an enlarged view schematically illustrating a spin-valve film according to a third specific example of the present invention;

FIG. 12 is an enlarged view schematically illustrating a spin-valve film according to a fourth specific example of the present invention;

FIG. 13 is an enlarged view schematically illustrating a spin-valve film according to a fifth specific example of the present invention;

FIG. 14 is an enlarged view schematically illustrating a spin-valve film according to a modified example of the present invention;

FIG. 15 is an enlarged view schematically illustrating a spin-valve film according to another modified example of the present invention;

FIG. 16 is an enlarged view schematically illustrating a spin-valve film according to still another modified example of the present invention;

FIG. 17 is an enlarged view schematically illustrating a spin-valve film according to still another modified example of the present invention;

FIG. 18 is an enlarged view schematically illustrating a spin-valve film according to still another modified example of the present invention;

FIG. 19 is an enlarged sectional view schematically illustrating a magnetoresistive random access memory (MRAM) as a specific example of a storage apparatus according to a second embodiment of the present invention;

FIG. 20 is an equivalent circuit diagram of one memory cell of the MRAM shown in FIG. 19; and

FIG. 21 is an enlarged sectional view schematically illustrating a magnetoresistive random access memory (MRAM) according to another specific example of the present invention.

### DESCRIPTION OF THE PREFERRED EMBODIMENTS

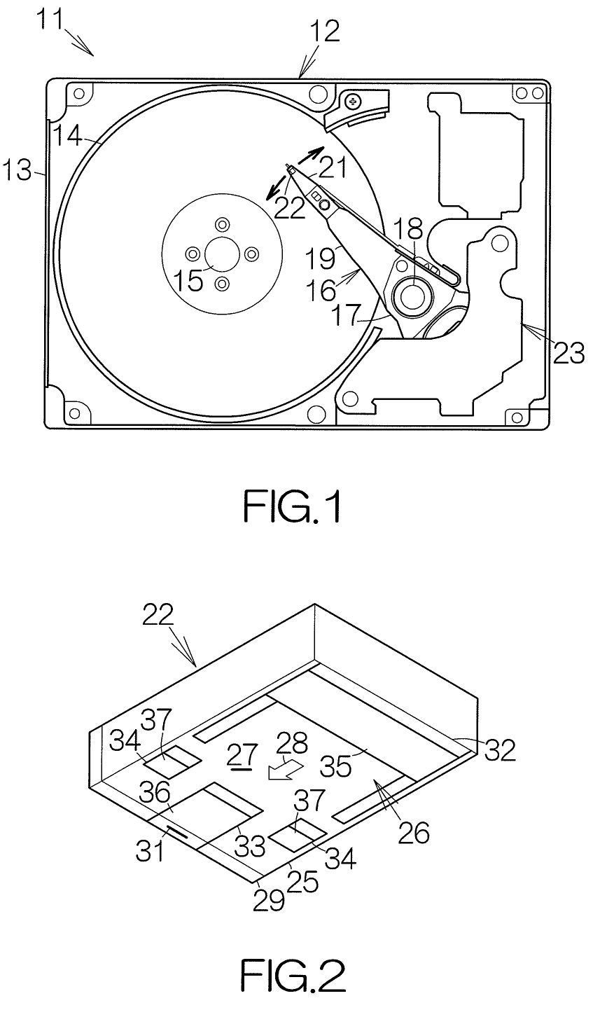

FIG. 1 schematically illustrates the inner structure of a hard disk drive, HDD, 11 as an example of a storage medium drive or storage apparatus according to a first embodiment of the present invention. The hard disk drive 11 includes an enclosure 12. The enclosure 12 includes an enclosure cover, not shown, and a box-shaped enclosure base 13 defining an inner space of a flat parallelepiped, for example. The enclosure base 13 may be made of a metallic material such as aluminum, for example. Molding process may be employed to form the enclosure base 13. The enclosure cover is coupled to the enclosure base 13. The enclosure cover closes the opening of the enclosure base 13. Pressing process may be employed to form the enclosure cover out of a plate material, for example.

At least one magnetic recording disk 14 as a storage medium is placed in the inner space of the enclosure base 13. The magnetic recording disk or disks 14 are mounted on the driving shaft of a spindle motor 15. The spindle motor 15 drives the magnetic recording disk or disks 14 at a higher revolution speed such as 3,600 rpm, 4,200 rpm, 5,400 rpm, 7,200 rpm, 10,000 rpm, 15,000 rmp, or the like.

A carriage 16 is also placed in the inner space of the enclosure base 13. The carriage 16 includes a carriage block 17. The carriage block 17 is supported on a vertical support shaft 18 for relative rotation. Carriage arms 19 are defined in the carriage block 17. The carriage arms 19 are designed to extend in a horizontal direction from the vertical support shaft 18. The carriage block 17 may be made of aluminum, for example. Extrusion process may be employed to form the carriage block 17, for example.

A head suspension 21 is attached to the front or tip end of the individual carriage arm 19. The head suspension 21 is designed to extend forward from the carriage arm 19. A flexure is attached to the head suspension 21. The flexure defines a so-called gimbal at the front or tip end of the head suspension 21. A flying head slider 22 is supported on the gimbal. The gimbal allows the flying head slider 22 to change its attitude relative to the head suspension 21. A head element or electromagnetic transducer is mounted on the flying head slider 22, as described later in detail.

When the magnetic recording disk 14 rotates, the flying head slider 22 is allowed to receive an airflow generated along the rotating magnetic recording disk 14. The airflow serves to generate a positive pressure or a lift as well as a negative pressure on the flying head slider 22. The flying head slider 22 is thus allowed to keep flying above the surface of the magnetic recording disk 14 during the rotation of the magnetic recording disk 14 at a higher stability established by the balance between the urging force of the head suspension 21 and the combination of the lift and the negative pressure.

When the carriage 16 swings around the vertical support shaft 18 during the flight of the flying head slider 22, the flying head slider 22 is allowed to move along the radial direction of the magnetic recording disk 14. The electromagnetic transducer on the flying head slider 22 is thus allowed to cross the data zone defined between the innermost and outermost recording tracks. The electromagnetic transducer on the flying head slider 22 is positioned right above a target recording track on the magnetic recording disk 14.

A power source such as a voice coil motor, VCM, 23 is coupled to the carriage block 17. The voice coil motor 23 serves to drive the carriage block 17 around the vertical support shaft 18. The rotation of the carriage block 17 allows the carriage arms 19 and the head suspensions 21 to swing.

FIG. 2 illustrates a specific example of the flying head slider 22. The flying head slider 22 includes a slider body 25 in the form of a flat parallelepiped, for example. The slider body 25 may be made of a hard material such as Al₂O₃—TiC. A medium-opposed surface or bottom surface 26 is defined over the slider body 25 so as to face the magnetic recording disk 14 at a distance. A flat base surface 27 as a reference surface is defined on the bottom surface 26. When the magnetic recording disk 14 rotates, airflow 28 flows along the bottom surface 26 from the inflow or front end toward the outflow or rear end of the slider body 25.

An insulating non-magnetic film, namely a head protection film 29, is overlaid on the outflow or trailing end surface of the slider body 25. The aforementioned electromagnetic transducer 31 is incorporated in the head protection film 29. The head protection film 29 may be made of a relatively soft material such as Al₂O₃ (alumina).

A front rail 32 is formed on the bottom surface 26 of the slider body 25. The front rail 32 stands upright from the base surface 27 of the bottom surface 26 near the inflow end of the slider body 25. The front rail 32 extends along the inflow end of the base surface 27 in the lateral direction of the slider body 25. A rear center rail 33 is likewise formed on the bottom surface 26 of the slider body 25. The rear center rail 33 stands upright from the base surface 27 of the bottom surface 26 near the outflow end of the slider body 25. The rear center rail 33 is located at the intermediate position in the lateral direction of the slider body 25. The rear center rail 33 extends to the heat protection film 29. A pair of rear side rails 34, 34 are likewise formed on the bottom surface 26 of the slider body 25. The rear side rails 34, 34 stand upright from the base surface 27 of the bottom surface 26 near the outflow end of the slider body 25. The rear side rails 34, 34 are located along the sides of the slider body 25, respectively. The rear side rails 34, 34 are thus distanced from each other in the lateral direction of the slider body 25. The rear center rail 33 is located in a space between the rear side rails 34, 34.

Air bearing surfaces 35, 36, 37 are defined on the top surfaces of the rails 32, 33, 34, respectively. Steps connect the inflow ends of the air bearing surfaces 35, 36, 37 to the top surfaces of the rails 32, 33, 34, respectively. The bottom surface 26 of the flying head slider 22 is designed to receive the airflow 28 generated along the rotating magnetic recording disk 14. The steps serve to generate a larger positive pressure or lift at the air bearing surfaces 35, 36, 37, respectively. Moreover, a larger negative pressure is generated behind the front rail 32 or at a position downstream of the front rail 32. The negative pressure is balanced with the lift so as to stably establish the flying attitude of the flying head slider 22.

The aforementioned electromagnetic transducer 31 is embedded in the rear center rail 33 at a position near the outflow end of the air bearing surface 36. The electromagnetic transducer 31 includes a read element and a write element. The read element and write element have read gap and write gap exposed at the surface of the head protection film 29, respectively. A hard protection film may be formed on the surface of the head protection film 29 at a position near the outflow end of the air bearing surface 36. Such a protection film covers over the tip ends of the write gap and read gap exposed at the surface of the head protection film 29. The protection film may be made of a diamond like carbon film, for example.

FIG. 3 illustrates the electromagnetic transducer 31 in detail. The electromagnetic transducer 31 comprises a thin film magnetic head or inductive write head element 38 and a current-perpendicular-to-the-plane (CPP) structure magnetoresistive (MR) element or CPP structure giant magnetoresistive (GMR) read element 39. The inductive write head element 38 allows a conductive swirly coil pattern, not shown, to generate a magnetic field in response to the supply of electric current, for example. The generated magnetic field is usually utilized to record binary data into the magnetic recording disk 14. The CPP structure GMR read element 39 is usually allowed to induce change in the electric resistance in response to the reversal of polarization in the applied magnetic field from the magnetic recording disk 14. This change in the electric resistance is utilized to detect binary data. The inductive write head element 38 and the CPP structure GMR read element 39 are interposed between an Al₂O₃ (alumina) layer 41 and an Al₂O₃ (alumina) layer 42. The alumina layer 41 provides the upper half of the aforementioned head protection layer 29, namely an over coat film. The alumina layer 42 likewise provides the lower half of the head protection layer 29, namely an undercoat layer.

The inductive write head element 38 includes upper and lower magnetic pole layers 43, 44. The front ends of the upper and lower magnetic pole layers 43, 44 are exposed at the air bearing surface 36. The upper and lower magnetic pole layers 43, 44 may be made of NiFe, CoZrNb, FeN, FeSiN, FeCo, CoNiFe, or the like. The upper and lower magnetic pole layers 43, 44 in combination serve as a magnetic core of the inductive write head element 38.

A non-magnetic gap layer 45 made of Al₂O₃ is interposed between the upper and lower magnetic pole layers 43, 44. As conventionally known, when a magnetic field is generated in the aftermentioned magnetic coil, the non-magnetic gap layer 45 serves to establish a leakage of a magnetic flux exchanged between the upper and lower magnetic pole layers 43, 44, out of the bottom surface 26. The leaked magnetic flux forms a magnetic field for recordation.

The CPP structure GMR read element 39 includes a substratum, namely a lower electrode 46 extending along the undercoat film 42. The lower electrode 46 may have not only a property of electric conductors but also a soft magnetic property. When the lower electrode 46 is made of a soft magnetic material having electrical conductivity such as NiFe, CoFe, or the like, the lower electrode 46 functions as a lower shielding layer of the CPP structure GMR read element 39. The lower electrode 46 is embedded in an insulating layer 47 extending over the surface of the undercoat film 42. The surface of the lower electrode 46 defines a continuous flattened surface 48 as a datum plane.

A magnetoresistive (MR) element or spin-valve film 49 is overlaid on the flattened surface 48. The spin-valve film 49 extends backward along the flattened surface 48 from its front end exposed at the air bearing surface 36. The spin-valve film 49 is thus electrically connected to the lower electrode 46. Description will be made on the spin-valve film 49 later in detail. An upper electrode 52 is located on the insulating layer 47. The upper electrode 52 is made of an electrically-conductive material. The upper electrode 52 extends along the surface of an insulating film 51. The upper electrode 52 contacts with the spin-valve film 49 at least along the air bearing surface 36. The spin-valve film 49 is thus electrically connected to the upper electrode 52.

The upper electrode 52 may be made of a soft magnetic material having electrical conductivity, such as NiFe, CoFe, or the like. When the upper electrode 52 has not only a property of electric conductors but also a soft magnetic property, the upper electrode 52 functions as an upper shielding layer of the CPP structure GMR read element 39. A gap between the upper electrode 52 and the aforementioned lower shielding layer or lower electrode 46 determines a linear resolution of magnetic recordation on the magnetic recording disk 14 along the recording track.

A pair of magnetic domain controller films 53 are interposed between the lower electrode 46 and the upper electrode 52 in the CPP structure GMR read element 39. The spin-valve film 49 is located along the air bearing surface 36 at a position between the magnetic domain controller films 53, 53. The magnetic domain controller films 53 may be made of either a hard magnetic film or an antiferromagnetic film. The individual magnetic domain controller film 53 may have a layered structure made of a Co film or films and a CoCrPt film or films, for example.

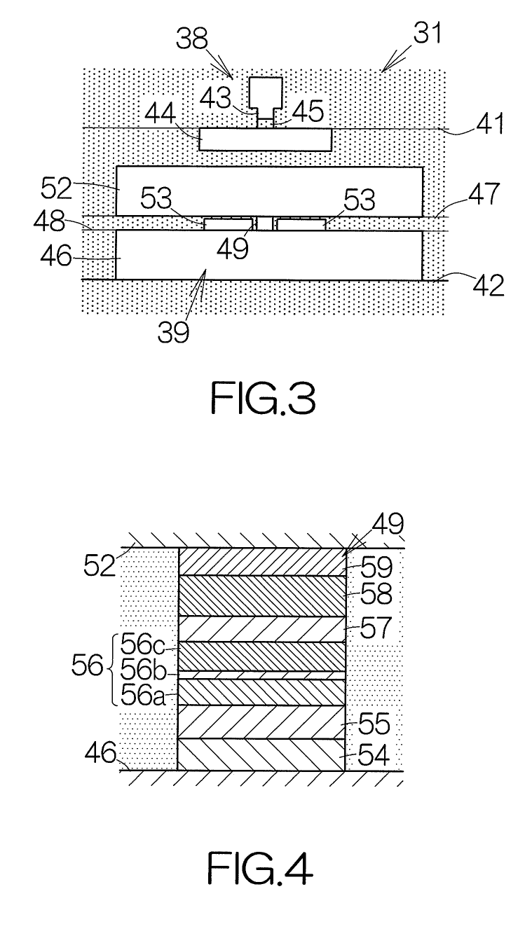

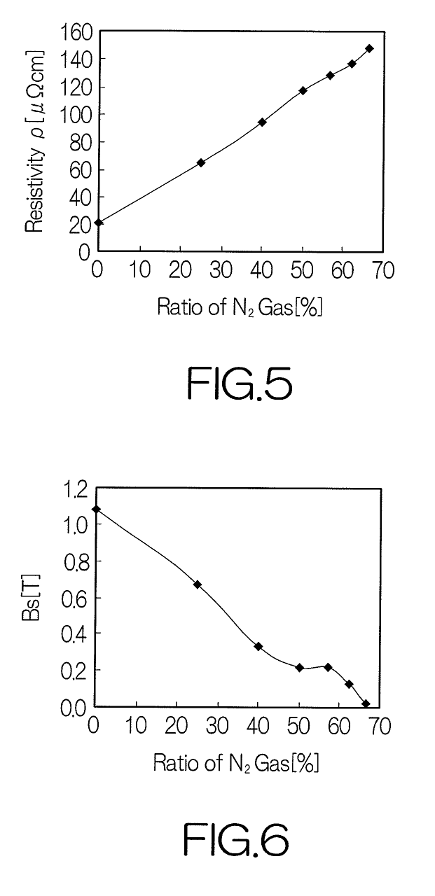

FIG. 4 schematically illustrates the spin-valve film 49 according to a first specific example of the present invention. The spin-valve film 49 includes a buffer layer 54, an antiferromagnetic layer 55 as a pinning layer, a pinned magnetic layer 56, a non-magnetic intermediate layer 57, a free magnetic layer 58 and a protection layer 59, overlaid on another in this sequence. The spin-valve film 49 has the structure of a so-called single spin-valve.

The buffer layer 54 may be made of a NiCr film, a specific layered structure, or the like. The specific layered structure may include Ta, NiFe, Ta and Ru, for example. In such a layered structure, the NiFe film preferably contains Fe in a range between 17 [atom %] and 25 [atom %]. When the NiFe film having such a composition is utilized, the crystal grains of the antiferromagnetic layer 55 is allowed to epitaxially grow on the surface of a (111) surface defining the direction of crystal growth of the NiFe film. This results in improvement of the crystallinity of the antiferromagnetic layer 55.

The antiferromagnetic layer 55 is made of an antiferromagnetic alloy material such as an Mn-TM alloy, for example. TM contains at least one of Pt, Pd, Ni, Ir and Rh. Here, the antiferromagnetic layer 55 may be one of a PtMn film, a PdMn film, an NiMn film, an IrMn film and a PtPdMn film, for example. The thickness of the antiferromagnetic layer 55 is set within a range between 4 nm and 30 nm. An exchange interaction occurs between the antiferromagnetic layer 55 and the pinned magnetic layer 56. The direction of magnetization in the pinned magnetic layer 56 is thus pinned in a predetermined direction.

The pinned magnetic layer 56 has a layered structure made of a first pinned magnetic layer 56a, a non-magnetic coupling layer 56b and a second pinned magnetic layer 56c, overlaid on the surface of the antiferromagnetic layer 55 in this sequence. The pinned magnetic layer 56 has a so-called synthetic ferrimagnetic structure. An antiferromagnetic exchange coupling is established between the magnetization of the first pinned magnetic layer 56a and the magnetization of the second pinned magnetic layer 56c in the pinned magnetic layer 56. The magnetization of the first pinned magnetic layer 56a is thus set antiparallel with the magnetization of the second pinned magnetic layer 56c.

The first pinned magnetic layer 56a is made of a ferromagnetic material containing at least one of Co, Ni and Fe. Here, the first pinned magnetic layer 56a is one of a CoFe film, a CoFeB film, a CoFeAl film, a CoFeMg film, an NiFe film, an FeCoCu film and a CoNiFe film, for example. Here, a CO₆₀Fe₄₀ film or a NiFe film is employed as the first pinned magnetic layer 56a. The thickness of the first pinned magnetic layer 56a is set in a range between 1 nm and 30 nm approximately, for example.

The second pinned magnetic layer 56c is made of a nitrided magnetic metal alloy. Here, the second pinned magnetic layer 56c is one of a NiFeN film, a CoFeN film, a CoFeNiN film, a CoFeAlN film, a CoFeGeN film, a CoFeSiN film and CoFeMgN film. The thickness of the second pinned magnetic layer 56c is set in a range between 1 nm and 30 nm approximately in the same manner as the first pinned magnetic layer 56a, for example.

The non-magnetic coupling layer 56b is made of a non-magnetic material such as Ru, Rh, Ir, a Ru alloy, a Rh alloy, an Ir alloy, or the like. The non-magnetic coupling layer 56b serves to prevent the first pinned magnetic layer 56a from rotation or reversal of the magnetization. The non-magnetic intermediate layer 57 is made of a non-magnetic material having electrical conductivity, such as Cu, Al or Cr. The thickness of the non-magnetic intermediate layer 57 is set in a range between 1.5 nm and 10 nm approximately, for example.

The free magnetic layer 58 is made of a nitrided magnetic metal alloy in the same manner as the second pinned magnetic layer 56c. Here, the free magnetic layer 58 is one of a NiFeN film, a CoFeN film, a CoFeNiN film, a CoFeAlN film, a CoFeGeN film, a CoFeSiN film and a CoFeMgN film. The thickness of the free magnetic layer 58 is set in a range between 1 nm and 30 nm approximately in the same manner as the first pinned magnetic layer 56a, for example.

The protection layer 59 is made of a magnetic film having electrical conductivity, containing one of Ru, Cu, Ta, Au, Al and W, for example. The protection film 59 may have a layered structure made of magnetic films having electrical conductivity. The protection layer 59 serves to prevent the free magnetic layer 58 from being oxidized.

As conventionally known, when the CPP structure GMR read element 39 is opposed to the surface of the magnetic recording disk 14 at a distance for reading magnetic bit data, the magnetization rotates in the free magnetic layer 58 of the spin-valve film 49 in response to the reversal of polarization in the applied magnetic field from the magnetic recording disk 14. The rotation of the magnetization in the free magnetic layer 58 induces a significant change in the electric resistance of the spin-valve film 49. When a sensing current is supplied to the spin-valve film 49 through the upper electrode 52 and the lower electrode 46, a change appears in the level of an electrical signal output from the upper electrode 52 and the lower electrode 46 in response to the change in the electric resistance. This change in the level is utilized to detect magnetic bit data recorded on the magnetic recording disk 14.

It should be noted that the first pinned magnetic layer 56a and the second pinned magnetic layer 56c each may have a multilayered structure. The multilayered structure may consist of films made of the same combination of metallic elements. In this case, different composition of the metallic elements may be established in the layered films. Alternatively, the layered films may have compositions of different metallic elements.

Next, description will be made on a method of forming the spin-valve film 49. The buffer layer 54, the antiferromagnetic layer 55, the pinned magnetic layer 56, the non-magnetic intermediate layer 57, the free magnetic layer 58 and the protection layer 59 are in this sequence formed on the flattened surface 48 of the lower electrode 46 as a substratum. Sputtering process may be employed to form these layers, for example. In this case, an NiFe alloy target is set within the chamber of a sputtering apparatus for forming the second pinned magnetic layer 56c and the free magnetic layer 58. Atoms of an NiFe alloy are emitted from the NiFe alloy target in response to electric discharge. Ar gas in addition to N₂ gas of a predetermined amount is introduced in the chamber. An NiFeN film is in this manner formed. It should be noted that N₂ gas may be introduced in the chamber after the NiFe film has been formed. A Ni target and a Fe target may separately be set in the chamber for forming the aforementioned NiFeN film.

Such a layered film is then subjected to heating process within a magnetic field. The heating process is applied in a vacuum atmosphere. The temperature of the heating process is set in a range between 250 degrees Celsius and 320 degrees Celsius approximately. The heating time is set in a range between two hours and eight hours approximately. The magnetic field applied to the layered film is set at 1,592 [kA/m]. The heating process allows the Mn-TM alloy contained in the antiferromagnetic layer 55 to partly be an ordered alloy, for example. The ordered alloy in this manner serves to determine the magnetization in the antiferromagnetic layer 55 in a specific direction. The magnetization in the pinned magnetic layer 56 is pinned in a predetermined direction based on the exchange interaction between the antiferromagnetic layer 55 and the pinned magnetic layer 56. The aforementioned layered film is then patterned into a predetermined shape. Photolithography and ion milling are employed to pattern the layered film. The spin-valve film 49 is in this manner formed.

The inventors have observed the effect of the magnetic layer made of a nitrided magnetic metal alloy. Six samples were prepared for the observation, for example. An NiFeN film of 50 nm thickness was formed on the surface of a silicon substrate in the individual sample. Ar gas and N₂ gas were introduced into the camber of a sputtering apparatus. The partial pressure of N₂ gas [%] (the ratio of the volume of N₂ gas to the entire volume) was differently set in the chamber for the individual samples. A sample according to a comparative example was prepared. An NiFe film of 50 nm thickness was formed on the surface of a silicon substrate in the sample of the comparative example.

The NiFeN film of the individual sample and the NiFe film of the sample of the comparative example were subjected to measurement of the resistivity ρ[μΩcm]. As shown in FIG. 5, the NiFe film in the sample of the comparative example (the ratio of N₂ gas equal to zero [%]) exhibited the resistivity ρ of 21[μΩcm]. The further the ratio of N₂ gas increases, the larger the resistivity ρ gets. For example, if the partial pressure of N₂ gas was set at 50[%], the resistivity ρ for 50[%] of N₂ gas reaches six times as large as the resistivity ρ for 0[%] of N₂ gas, namely for no N₂ gas contained.

The inventors also have observed that the saturation magnetic flux density Bs [T] of the NiFeN film of the individual sample and the NiFe film of the sample of the comparative example. As shown in FIG. 6, the NiFe film in the sample of the comparative example exhibited the saturation magnetic flux density Bs of 1.08 [T]. The further the ratio of N₂ gas increases, the smaller the saturation magnetic flux density Ds gets. For example, if the partial pressure of N₂ gas was set at 50[%], the saturation magnetic flux density Bs for 50[%] of N₂ gas reaches one fifth the saturation magnetic flux density Bs for 0[%] of N₂ gas, namely for no N₂ gas contained.

The output of the spin-valve film is determined based on a specific magnetoresistance change (ΔRA). This specific magnetoresistance change (ΔRA) is measured when an external magnetic field is applied to a spin-valve film in the opposite directions. The magnetoresistance change ΔRA of the spin-valve film is the product of a change in the resistance of the spin-valve film [ΔR] and the cross sectional area of the spin-valve film [A]. Achievement of an increase in the magnetoresistance change ΔRA requires employment of a material having a relatively large product of a spin dependent bulk scattering coefficient and a resistivity ρ. A spin dependent bulk scattering is a phenomenon that conductive electrons scatter within a free magnetic layer and a pinned magnetic layer depending on the direction of the spin of the conductive electrons.

According to the aforementioned observation, it has been confirmed that the resistivity ρ of the magnetic film formed within a high vacuum atmosphere containing N₂ gas is larger than that of a magnetic film formed within a vacuum atmosphere containing no N₂ gas. The product of the spin dependent bulk scattering coefficient and the resistivity ρ thus increases. An increase in the resistivity ρ results in an increased magnetoresistance change (ΔRA). According to the first specific example, since the free magnetic layer 58 and the second pinned magnetic layer 56c are formed in a vacuum atmosphere containing N₂ gas, the output of the spin-valve film 49 improves. Binary data is thus detected with accuracy in the first specific example. It should be noted that at least one of the free magnetic layer 58 and the second pinned magnetic layer 56c may be made of a nitrided magnetic metal alloy.

The detection sensitivity of a spin-valve film is evaluated based on the easiness of reversal of the magnetization in a free magnetic layer. The easiness of reversal is determined based on the tBs of the free magnetic layer, that is, the product of the thickness t and the saturation magnetic flux density Bs of the free magnetic layer. The smaller the tBs of the free magnetic layer gets, the easier the magnetization gets inverted. According to the aforementioned observation, it has been confirmed that a magnetic film formed in a vacuum atmosphere containing N₂ gas has a smaller saturation magnetic flux density Bs than a magnetic film formed in a vacuum atmosphere containing no N₂ gas, as long as the films have the same thickness. According to the first specific example, since the free magnetic layer 58 is formed in a vacuum atmosphere containing N₂ gas, the magnetization is allowed to enjoy an easier traverse. This results in improvement of the detection sensitivity of the spin-valve film 49 according to the first specific example.

A sample of a spin-valve film was produced for an observation. A silicon substrate was prepared. The silicon substrate had a surface covered with an oxidized film formed based on heat. A layered film as a lower electrode was formed on the surface of the silicon substrate. The layered film consisted of a Cu film in the thick¥ness of 250 nm and an NiFe film in the thickness of 50 nm. The layered film was made by forming a Ru film as the buffer layer in the thickness of 4 nm, an IrMn film as the antiferromagnetic layer in the thickness of 7 nm, a CO₆₀Fe₄₀ film as the first pinned magnetic layer in the thickness of 3 nm, a Ru film as the non-magnetic coupling film in the thickness of 0.7 nm, a CO₄₀Fe₆₀ film as the second pinned magnetic layer in the thickness of 4 nm, a Cu film as the non-magnetic intermediate layer in the thickness of 3.5 nm, a NiFeN film as the free magnetic film in the thickness of 7 nm, and a Ru film as the protection film in the thickness of 5 nm, in this sequence.

The vacuum condition of 2×10⁻⁶ [Pa] or smaller, was established in the chamber of a sputtering apparatus. Ar gas was introduced into the camber. The partial pressure [%] of N₂ gas was adjusted in the chamber only during the formation of the free magnetic layer. The partial pressure of N₂ gas was adjusted in a range between 0[%] and 67[%]. When the partial pressure of N₂ gas was set at 0[%], the NiFe film was formed as the free magnetic film. Heating process was applied to the layered film after the formation of the layered film in the same manner as described above. The layered film was subjected to heat of 300 degrees Celsius for three hours. A magnetic field of 1,952 [kA/m] was applied to the layered film in a predetermined direction in the heating process. The heating process causes the antiferromagnetic layer to exhibit antiferromagnetism.

The layered film was then subjected to photolithography and ion milling. The layered films were allowed to have six different cross sectional areas at intervals of 0.1 [μm²] in a range between 0.1-[μm²] and 0.6 [μm²], for example. Over a hundred of the layered bodies were formed on a wafer in total. Several dozens of the layered films were formed to have the same cross sectional area. A silicon oxide film was formed to cover over the layered film. The layered films were then subjected to dry etching. The silicon oxide film was thus removed from the surface of the individual layered film. The surface of the layered film, namely the protection film was exposed. An Au film as an upper electrode was formed on the surface of the protection film. A spin-valve film was in this manner formed on the silicon substrate.

A sensing current was supplied to the spin-valve film through the upper or lower electrode. The value of the current was set at 2 [mA]. An external magnetic field was simultaneously applied to the spin-valve film. The magnetic field was applied in parallel with the magnetization in the second pinned magnetic layer. The intensity of the magnetic field was changed in a range between −79 [kA/m] and +79 [kA/m]. Voltage was measured between the upper electrode and the lower electrode. A digital voltmeter was utilized for the measurement. A magnetoresistance curve was obtained based on the measured voltage. A magnetoresistance change (ΔRA) was calculated based on the maximum and minimum values of the magnetoresistance curve.

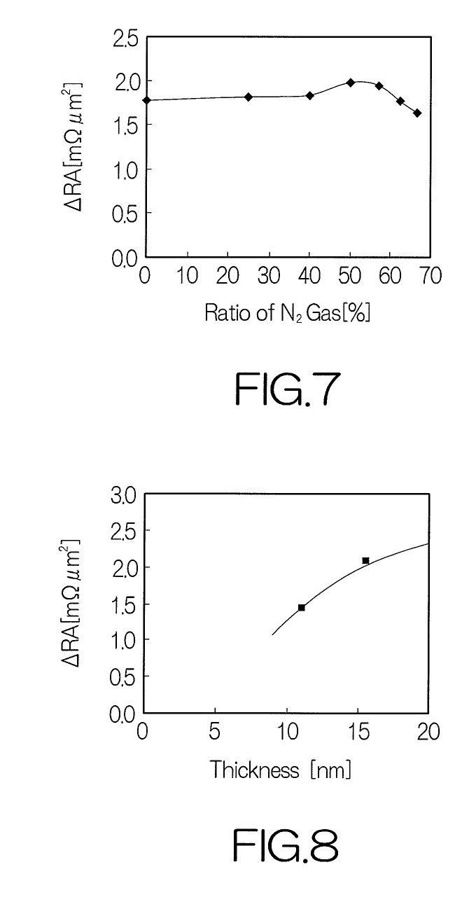

As shown in FIG. 7, the magnetoresistance change ARA measured for the partial pressure of N2 gas in a range 0[%] (not inclusive) and 60[%] approximately was equal to or larger than the magnetoresistance change ΔRA measured for the partial pressure of N₂ gas equal to 0[%]. Accordingly, it has been confirmed that the spin-valve film 49 of the first specific example is allowed to have an enhanced detection sensitivity since the free magnetic layer 58 is made of a nitrided magnetic metal alloy. When the partial pressure of N₂ gas exceeded 60[%], the magnetoresistance change ΔRA deteriorated. As is apparent from FIG. 6, it was assumed that this is because NiFeN suffers from an extremely lower Bs, namely the non-magnetic property, when the partial pressure of N₂ gas exceeds 60[%]. Accordingly, it has been confirmed that the partial pressure of N₂ gas is preferably set at 60[%] approximately or smaller.

FIG. 8 is a graph showing the relationship between the thickness of the free magnetic layer and the magnetoresistance change ΔRA in a conventional spin-valve film. First and second samples of a spin-valve film were produced for calculation of the magnetoresistance change ΔRA in the same manner as the aforementioned sample. In either sample, the thickness of the second pinned magnetic layer was set at 4 nm. The free magnetic layer was made of an Fe₃₀CO₇₀. The thickness of the free magnetic layer was set at 7 nm in the first sample. The thickness of the free magnetic layer was set at 11 nm in the second sample. The axis of abscissas represents the total thickness of the second pinned magnetic layer and the free magnetic layer. As is apparent from FIG. 8, an increase in the thickness of the free magnetic layer is inevitable to enhance the magnetoresistance change ΔRA.

FIG. 9 is a graph showing the relationship between the magnetoresistance change ΔRA and tBs of the free magnetic layer in a conventional spin-valve film. The relationship was observed based on a simulation. The value of a sensing current was set at 2 [mA]. The relationship was demonstrated between the magnetoresistance change ΔRA and tBs for establishment of the output of 1,500 [μV]. As is apparent from FIG. 9, an increase in the magnetoresistance change ΔRA leads to an enhanced tBs of the free magnetic layer. In other words, the thickness t of the free magnetic layer has to be increased so as to increase the magnetoresistance change ΔRA. However, an increased tBs with the thickness t increased, the magnetization in the free magnetic layer cannot enjoy an easiness of reversal. This results in deterioration of the detection sensitivity of the spin-valve film.

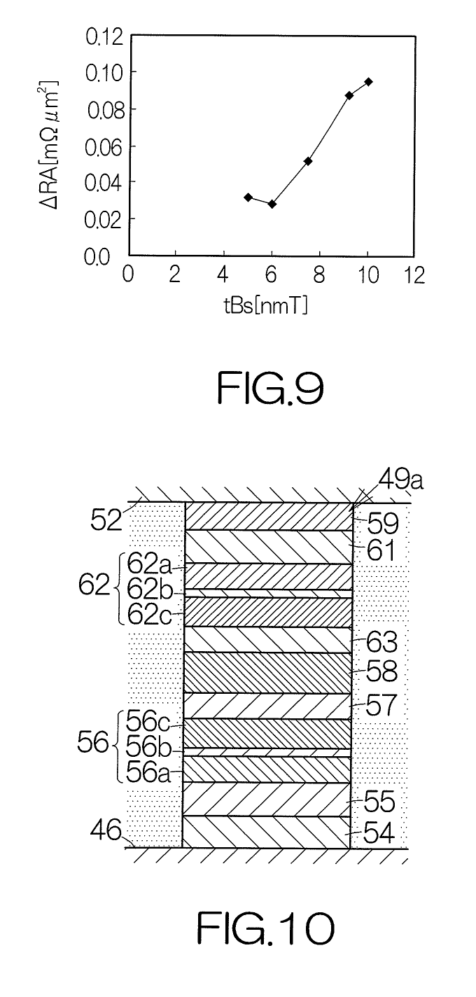

FIG. 10 schematically illustrates a spin-valve film 49a according to a second specific example of the present invention. The spin-valve film 49a has the structure of a so-called dual spin-valve. In the spin-valve film 49a, an antiferromagnetic layer 61, a pinned magnetic layer 62 and a non-magnetic intermediate layer 63 are interposed between the free magnetic layer 58 and protection layer 59 of the aforementioned spin-valve film 49. The non-magnetic intermediate layer 63, the pinned magnetic layer 62 and the antiferromagnetic layer 61 are in this sequence overlaid on the surface of the free magnetic layer 58. The protection layer 59 is received on the surface of the antiferromagnetic layer 61.

The antiferromagnetic layer 61 has a structure identical to that of the aforementioned antiferromagnetic layer 55. The non-magnetic intermediate layer 63 has a structure identical to that of the aforementioned non-magnetic intermediate layer 57. The pinned magnetic layer 62 has a layered structure including a first pinned magnetic layer 62a, a non-magnetic coupling layer 62b and a second pinned magnetic layer 62c. The pinned magnetic layer 62 has a so-called synthetic ferrimagnetic structure. The first pinned magnetic layer 62a, the non-magnetic coupling layer 62b and the second pinned magnetic layer 62c has structures identical to those of the first pinned magnetic layer 56a, the non-magnetic coupling layer 56b and the second pinned magnetic layer 56c, respectively. Like reference numerals are attached to the structure or components equivalent to those of the aforementioned examples.

In the spin-valve film 49a, the pinned magnetic layer 56, the non-magnetic intermediate layer 57 and the free magnetic layer 58 in combination establish one spin-valve structure. Simultaneously, the pinned magnetic layer 62, the non-magnetic intermediate layer 63 and the free magnetic layer 58 in combination establish another spin-valve structure. When a magnetic layer made of a nitrided magnetic metal alloy is established in each of the spin-valve structures, for example, the magnetoresistance change ΔRA of the spin-valve film 49a is approximately twice as large as that of the spin-valve film 49. The output and the detection sensitivity of the spin-valve film 49a of the present example are further improved as compared with those of the aforementioned spin-valve film 49.

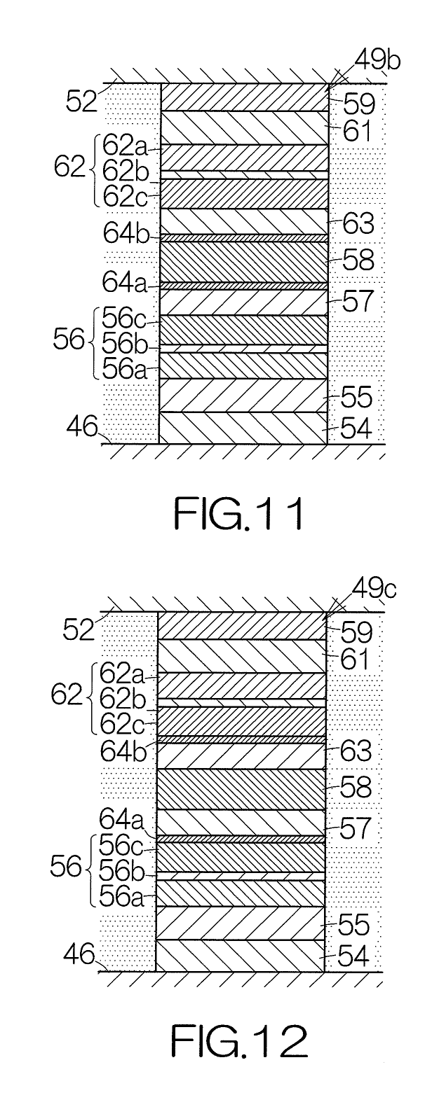

FIG. 11 schematically illustrates a spin-valve film 49b according to a third specific example of the present invention. In the spin-valve film 49b, the free magnetic layer 58 of the spin-valve film 49a is interposed between a pair of soft magnetic layers, namely a first interface magnetic layer 64a and a second interface magnetic layer 64b. The first interface magnetic layer 64a and the second interface magnetic layer 64b are made of a soft magnetic material. The soft magnetic material has a larger spin dependent interface scattering coefficient than the nitrided magnetic metal alloy utilized to form at least one of the free magnetic layer 58 and the pinned magnetic layers 56, 62. Such a material may be made of at least one of a CoFe film, a CoFeX film, a NiFe film. The thickness of the first interface magnetic layer 64a and the second interface magnetic layer 64b is set in a range between 0.2 [μm] and 2.5 [μm] approximately, for example. Like reference numerals are attached to the structure or components equivalent to those of the aforementioned spin-valve film 49a.

In the spin-valve film 49b, the first interface magnetic layer 64a and the second interface magnetic layer 64b are made of a ferromagnetic material having a relatively large coefficient of spin dependent interface scattering. The free magnetic layer 58 is interposed between the first interface magnetic layer 64a and the second interface magnetic layer 64b. The output and the detection sensitivity of the spin-valve film 49b of the present example are further improved as compared with those of the aforementioned spin-valve films 49, 49a. The first interface magnetic layer 64a and the second interface magnetic layer 64b may be made from the same composition. Alternatively, the first interface magnetic layer 64a and the second interface magnetic layer 64b may be made from different compositions containing the same metallic elements. Otherwise, the first interface magnetic layer 64a and the second interface magnetic layer 64b may be made from simply different compositions.

FIG. 12 schematically illustrates a spin-valve film 49c according to a fourth specific example of the present invention. In the spin-valve film 49c, the aforementioned first interface magnetic layer 64a is interposed between the second pinned magnetic layer 56c and the non-magnetic intermediate layer 57. The aforementioned second interface magnetic layer 64b is interposed between the second pinned magnetic layer 62c and the non-magnetic intermediate layer 63. Like reference numerals are attached to the structure or components equivalent to those of the aforementioned spin-valve film 49b. The output and the detection sensitivity of the spin-valve film 49c are further improved as compared with those of the aforementioned spin-valve films 49, 49a.

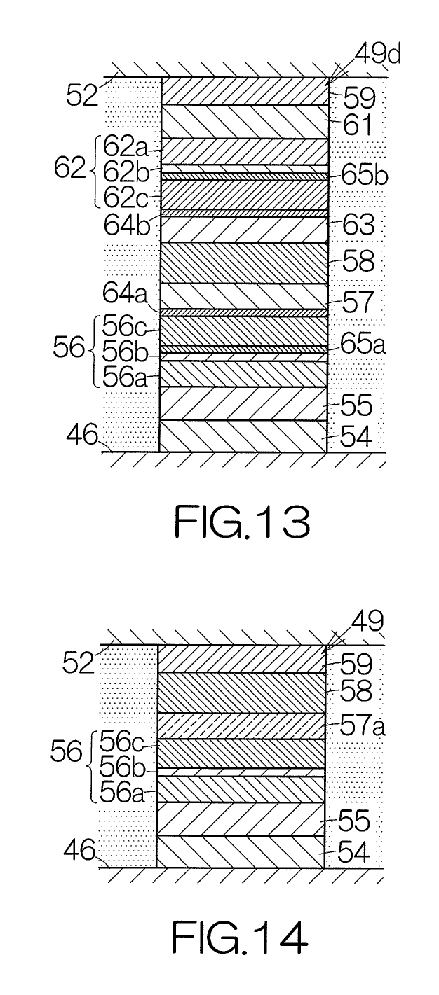

FIG. 13 schematically illustrates a spin-valve film 49d according to a fifth specific example of the present invention. In the spin-valve film 49d, a first ferromagnetic coupling layer 65a is interposed between the non-magnetic coupling layer 56b and the second pinned magnetic layer 56c of the aforementioned spin-valve film 49c. Likewise, a second ferromagnetic coupling layer 65b is interposed between the non-magnetic coupling layer 62b and the second pinned magnetic layer 62c of the aforementioned spin-valve film 49c. The first ferromagnetic coupling layer 65a is made of a ferromagnetic material having a saturation magnetization larger than that of the second pinned magnetic layer 56c. Likewise, the second ferromagnetic coupling layer 65b is made of a ferromagnetic material having a saturation magnetization larger than that of the second pinned magnetic layer 62c. Here, such a ferromagnetic material may include at least one of Co, Ni and Fe. The ferromagnetic material may be a CoFe film, a CoFeB film, a CoNiFe film, or the like. Like reference numerals are attached to the structure or components equivalent to those of the aforementioned spin-valve film 49c.

In the spin-valve film 49d, an exchange coupling is enhanced between the first ferromagnetic coupling layer 65a and the second pinned magnetic layer 56c and between the second ferromagnetic coupling layer 65b and the second pinned magnetic layer 62c. The direction of magnetization is stabilized in the second pinned magnetic layer 56c and the second pinned magnetic layer 62c. The magnetoresistance change ΔRA of the spin-valve film 49d is thus stabilized.

The spin-valve film 49 of the first specific example may be combined with any of the spin-valve films 49b-49d of the third, fourth and fifth specific examples. The first interface magnetic layer 64a or the first ferromagnetic coupling layer 65a may be incorporated in the spin-valve film 49 of the first specific example, for example. The spin-valve films 49b-49d of the third, fourth and fifth specific examples may be combined with each other. These structures allow realization of the advantages identical to those obtained in the aforementioned spin-valve films 49b-49d.

A current-perpendicular-to-the-plane (CPP) structure tunnel magnetoresistive (TMR) read element may be incorporated in the electromagnetic transducer 31 in place of the CPP structure GMR read element 39. The CPP structure TMR read element includes a non-magnetic insulating or intermediate layer 57a in place of the non-magnetic intermediate layer 57 of the aforementioned spin-valve film 49, as shown in FIG. 14. The non-magnetic intermediate layer 57a may be made of an oxide containing Mg, Al, Ti and Zr, such as MgO, AlO_{X}, TiO_{X}, ZrO_{X}, or the like. Here, the non-magnetic intermediate layer 57a may be made of a crystalline MgO. The (001) surface of the MgO is preferably set parallel to the upper surface of the lower electrode 46. The thickness of the non-magnetic intermediate layer 57a may be set in a range between 0.2 [nm] and 2.0 [nm] approximately, for example.

A ratio of the tunnel magnetic resistance change for the TMR read element can be measured in the same manner as the magnetoresistance change ΔRA of the aforementioned CPP structure GMR read element. The TMR read element is allowed to enjoy an enhanced ratio of the tunnel magnetic resistance in the similar manner as the aforementioned CPP structure GMR read element. The output and the detection sensitivity of the TMR read element are improved. The non-magnetic insulating layer may be made of a nitride or an oxynitride containing Al, Ti and Zr, such as AlN, TiN and ZrN, for example. Like reference numerals are attached to the structure or components equivalent to those of the aforementioned spin-valve film 49. A method similar to that for the aforementioned CPP structure GMR read element may be utilized to make such a TMR read element.

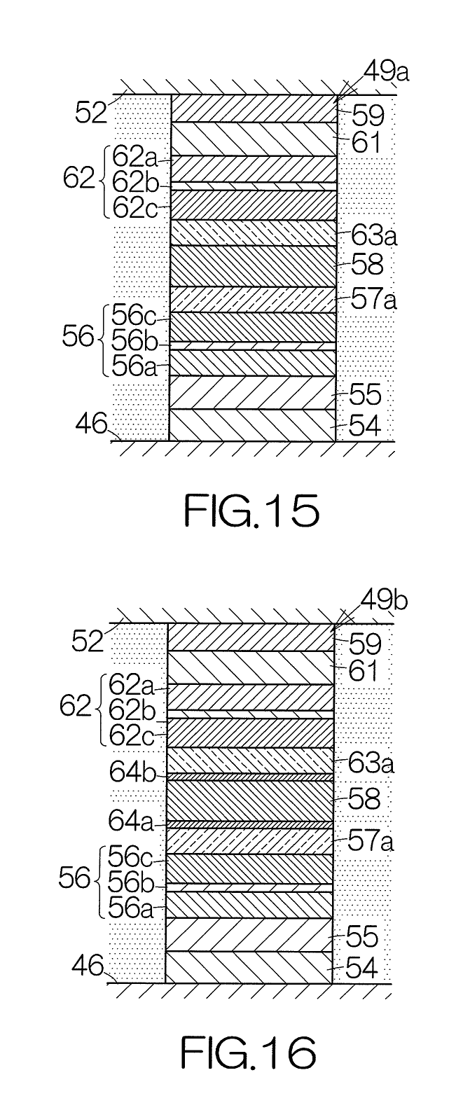

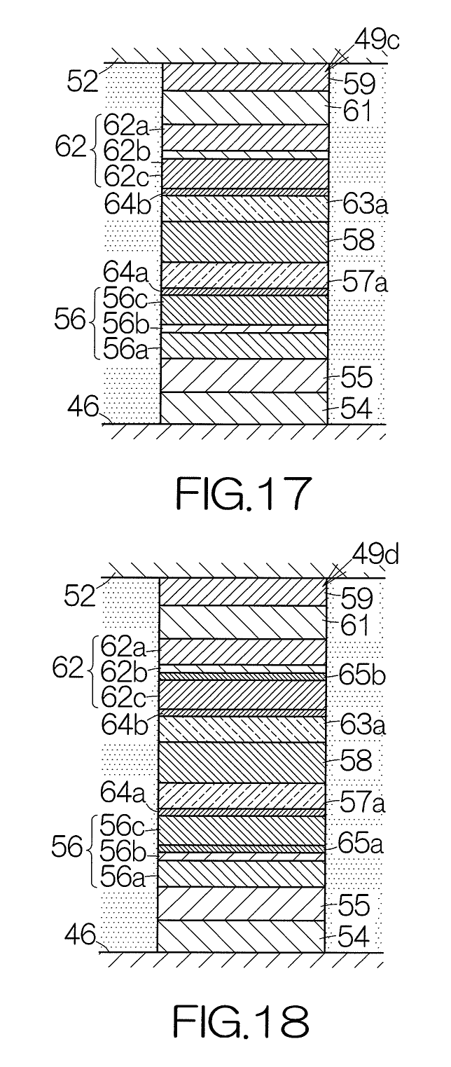

As shown in FIGS. 15-18, insulating non-magnetic intermediate layers 57a, 63a may be employed in place of the non-magnetic intermediate layer 57 and the non-magnetic intermediate layer 63 of the aforementioned spin-valve films 49a, 49b, 49c, 49d, respectively. The non-magnetic intermediate layer 63a may have a structure similar to that of the non-magnetic intermediate layer 57a. Like reference numerals are attached to the structure or components equivalent to those of the aforementioned spin-valve films 49a, 49b, 49c, 49d. The spin-valve films 49a, 49b, 49c, 49d are allowed to have improvement of the output and the detection sensitivity of the CPP structure TMR read element in the same manner as the aforementioned spin-valve film 49.

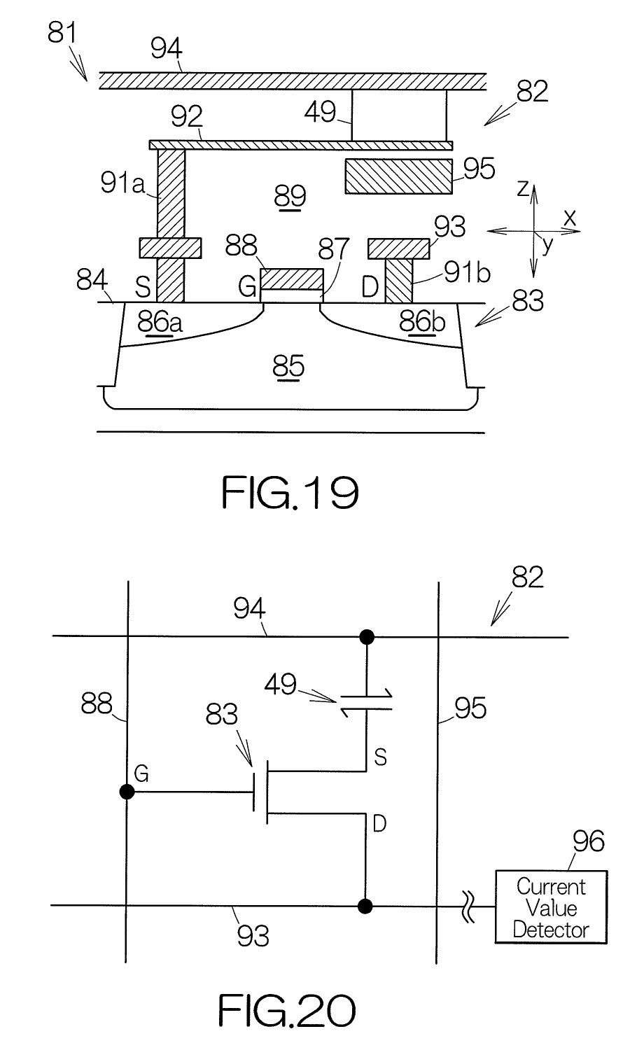

FIG. 19 schematically illustrates the structure of a magnetoresistive random access memory (MRAM) 81 as a storage apparatus according to a second embodiment. The MRAM 81 includes memory cells 82 arranged in a matrix, for example. The individual memory cell 82 includes a metal oxide semiconductor field-effect transistor (MOSFET) 83. The MOSFET 83 is either a p-type MOSFET or an n-type MOSFET. Here, the MOSFET 83 is a p-type MOSFET.

The MOSFET 83 includes a base member, namely a silicon substrate 84. The silicon substrate 84 defines a p-well region 85 containing a p-type impurity. A pair of impurity diffusion regions 86a, 86b are defined on the p-well region 85 at positions distanced from each other. N-type impurity is introduced into the impurity diffusion regions 86a, 86b. The impurity diffusion region 86a provides a source region S. The impurity diffusion region 86b provides a drain region D. A gate insulating layer 87 is formed on the surface of the silicon substrate 84 at a position between the impurity diffusion regions 86a, 86b. A gate electrode 88 is formed on the gate insulating layer 87. The gate insulating layer 87 and the gate electrode 88 in combination define a gate region G.

An insulating layer 89 covers over the gate electrode 88 on the surface of the silicon substrate 84. The insulating layer 89 is made of a silicon nitride film or a silicon oxide film, for example. The gate electrode 88 also functions as a read word line. A pair of vertical electric lines 91a, 91b extend in the insulating layer 89 in the vertical direction or z-axis direction perpendicular to the surface of the silicon substrate 84. One end of the vertical electric line 91a is connected to the source region S. The other end of the vertical electric line 91a is connected to an internal electric line 92 extending in parallel with the surface of the silicon substrate 84. One end of the vertical electric line 91b is connected to the drain region D. The other end of the vertical electric line 91b is connected to a plate line 93 extending in parallel with the y-axis perpendicular to the z-axis.

A bit line 94 extends in the insulating layer 89 in parallel with the internal electric line 92. The bit line 94 extends along the x-axis perpendicular to the z-axis. The aforementioned spin-valve film 49 is interposed between the internal electric line 92 and the bit line 94. The underlayer 54 of the spin-valve film 49 is received on the internal electric line 92. The bit line 94 is received on the protection film 59 of the spin-valve film 49. A write word line 95 is opposed to the internal electric line 92 at a position beneath the internal electric line 92 receiving the spin-valve film 49. The write word line 95 extends along the y-axis perpendicular to the x-axis.

FIG. 20 is an equivalent circuit diagram of the memory cell 82. As shown in FIG. 20, a current value detector 96 is electrically connected to the aforementioned plate line 93. An ammeter may be employed as the current value detector 96, for example. The gate electrode 88, namely a read word line and the write word line 95 extend in parallel with the y-axis. The bit line 94 extends along the x-axis perpendicular to the y-axis. The write word line 95 extends across the bit line 94 at a position distanced from the bit line 94.

In the spin-valve film 49 of the MRAM 81, the free magnetic layer 58 has an axis of easy magnetization in the x-axis. The free magnetic layer 58 has an axis of hard magnetization in the y-axis. The bit line 94 and the write word line 95 are simultaneously supplied with electric current in a process of writing information data. The electric current is supplied in a predetermined direction in the bit line 94 and the write word line 95. A magnetic field acts on the free magnetic layer 58 in the x-axis direction in response to the flow of the electric current in the write word line 95. A magnetic field likewise acts on the free magnetic layer 58 in the y-axis direction in response to the flow of the electric current in the bit line 94. The magnetization in the x-axis direction is thus inversed in the free magnetic layer 58. The direction of magnetization corresponds to a binary data “1” and “0”.

A negative voltage is applied to the source region S from the bit line 94 in a process of detecting information data. A positive voltage is simultaneously applied to the gate electrode 88. The positive voltage is set larger than the threshold voltage of the MOSFET 81. Electrons flow into the plate line 93 through the bit line 94, the source region S and the drain region D. Since the current value detector 96 is connected to the plate line 93 as described above, the magnetoresistance value is detected at the current value detector 96. The magnetoresistance value corresponds to the direction of magnetization in the free magnetic layer 58 relative to the direction of magnetization in the second pinned magnetic layer 56c. The detected magnetoresistive value is utilized to detect one of the binary values “1” and “0”.

The spin-valve film 49 is incorporated in the MRAM 81. The spin-valve film 49 of the first specific example allows increase in the magnetoresistance change ΔRA as described above. This results in increase in a difference between the magnetoresistive values respectively corresponding to the binary values “1” and “0”. Information data is thus detected from the spin-valve film 49 with accuracy. The aforementioned spin-valve films 49a, 49b, 49c, 49d may be incorporated in the MRAM 81 in place of the spin-valve film 49. Otherwise, a non-magnetic insulating layer may be employed in place of the non-magnetic intermediate layer 57 of the spin-valve film 49 in the same manner as described above. A change in the tunnel resistance may be utilized to detect a magnetoresistive value.

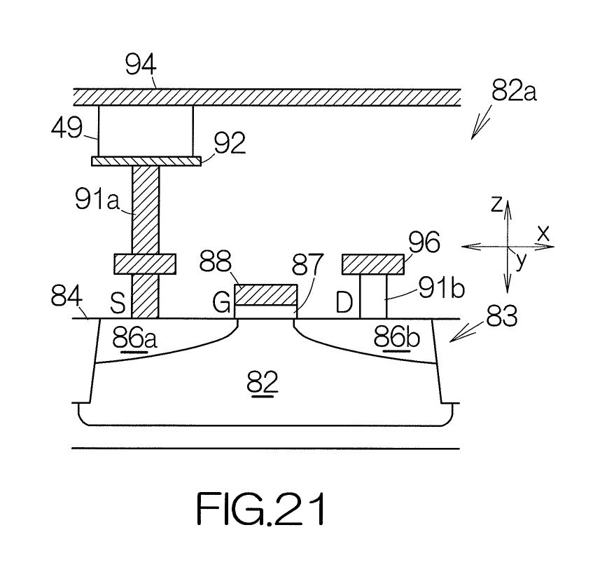

As shown in FIG. 21, a memory cell 82a may be incorporated in the MRAM 81. The write word line 95 is omitted from the memory cell 82a. A polarized spin current Iw is supplied to the spin-valve film 49 in a process of writing information data. The direction of the polarized spin current Iw induces the parallel or antiparallel relationship between the magnetization in the second pinned magnetic layer 56c and the magnetization in the free magnetic layer 58. The parallel relationship and the antiparallel relationship correspond to binary values “1” and “0”, respectively. The electric value of the polarized spin current Iw may be set in a range between several [mA] and 20 [mA] approximately, for example. Like reference numerals are attached to the structure or components equivalent to those of the aforementioned memory cell 82.

The MRAM 81 of this type allows increase in a difference between magnetoresistive values respectively corresponding to the binary values “1” and “0” in the same manner as described above. Information data is thus detected from the spin-valve film 49 with accuracy. Otherwise, a non-magnetic insulating layer may be employed in place of the non-magnetic intermediate layer 57 of the spin-valve film 49 in the same manner as described above. A change in the tunnel resistance may be utilized to detect a magnetoresistive value.

What is claimed is:

1. A current-perpendicular-to-the-plane structure magnetoresistive element comprising:
a free magnetic layer having electrical conductivity;
a pinned magnetic layer having electrical conductivity; and
an electrically-conductive non-magnetic intermediate layer inserted between the free magnetic layer and the pinned magnetic layer,
wherein at least one of the free magnetic layer and the pinned magnetic layer is made of a nitrided magnetic metal alloy.

2. The current-perpendicular-to-the-plane structure magnetoresistive element according to claim 1, wherein the magnetic metal alloy is made of at least one of NiFeN, CoFeN, CoFeNiN, CoFeAlN, CoFeGeN, CoFeSiN, and CoFeMgN.

3. A method of making a current-perpendicular-to-the-plane structure magnetoresistive element, comprising forming a layered structure on a surface of a substratum, the layered structure including a free magnetic layer having electrical conductivity, a pinned magnetic layer having electrical conductivity, and an electrically-conductive non-magnetic intermediate layer inserted between the free magnetic layer and the pinned magnetic layer,
wherein a magnetic metal alloy is layered within a high vacuum atmosphere containing at least N₂ gas in a process of forming at least one of the free magnetic layer and the pinned magnetic layer.

4. A storage apparatus including a current-perpendicular-to-the-plane structure magnetoresistive element comprising:
a free magnetic layer having electrical conductivity;
a pinned magnetic layer having electrical conductivity; and
an electrically-conductive non-magnetic intermediate layer inserted between the free magnetic layer and the pinned magnetic layer,
wherein at least one of the free magnetic layer and the pinned magnetic layer is made of a nitrided magnetic metal alloy.

5. A current-perpendicular-to-the-plane structure magnetoresistive element comprising:
a free magnetic layer having electrical conductivity;
a pinned magnetic layer having electrical conductivity; and
an insulating non-magnetic intermediate layer inserted between the free magnetic layer and the pinned magnetic layer,
wherein at least one of the free magnetic layer and the pinned magnetic layer is made of a nitrided magnetic metal alloy.

6. The current-perpendicular-to-the-plane structure magnetoresistive element according to claim 5, wherein the magnetic metal alloy is made of at least one of NiFeN, CoFeN, CoFeNiN, CoFeAlN, CoFeGeN, CoFeSiN, and CoFeMgN.

7. A method of making a current-perpendicular-to-the-plane structure magnetoresistive element, comprising forming a layered structure on a surface of a substratum, the layered structure including a free magnetic layer having electrical conductivity, a pinned magnetic layer having electrical conductivity, and an insulating non-magnetic intermediate layer inserted between the free magnetic layer and the pinned magnetic layer,
wherein a magnetic metal alloy is layered within a high vacuum atmosphere containing at least N₂ gas in a process of forming at least one of the free magnetic layer and the pinned magnetic layer.

8. A storage apparatus including storage apparatus including a current-perpendicular-to-the-plane structure magnetoresistive element comprising:
a free magnetic layer having electrical conductivity;
a pinned magnetic layer having electrical conductivity; and
an insulating non-magnetic intermediate layer inserted between the free magnetic layer and the pinned magnetic layer,
wherein at least one of the free magnetic layer and the pinned magnetic layer is made of a nitrided magnetic metal alloy.
